(19) United States
(12) Patent Application Publication
(10) Pub. No.: US 2007/0267606 A1
(43) Pub. Date: Nov. 22, 2007

(54) Low Loss Electro-Optic Polymers Composites

(76) Inventor: Diyun Huang, Bothell, WA (US)

Correspondence Address: FISH & RICHARDSON P.C., PO BOX 1022, MINNEAPOLIS, MN, 55440-1022, US

(21) Appl. No.: 11/383,695

(22) Filed: May 16, 2006

(51) Int. Cl. C09K 9/00; G02F 1/00

(52) U.S. Cl. 252/583

(57) ABSTRACT

A electro-optic composite comprising a polymer having the structure

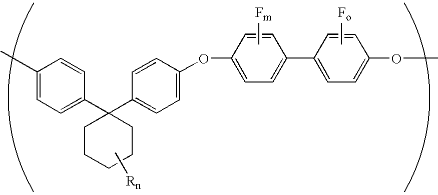

and a nonlinear optical chromophore having the structure D-π-A, wherein:

R is an alkyl, aryl, heteroalkyl, or heteroaryl, group;

D is a donor;

π is a n bridge;

A is an acceptor;

n=0-4;

m=1-4; and

o=1-4.

### BACKGROUND OF THE INVENTION

All patents, patent applications, and publications cited within this application are incorporated herein by reference to the same extent as if each individual patent, patent application or publication was specifically and individually incorporated by reference.

Electro-optic polymers are advantageous materials for optical device design because they have higher electro-optic activity than inorganic materials such as lithium niobate (LiNbO₃). Many electro-optic polymers have been developed, and many are “guest-host” systems where a nonlinear optical chromophore guest is present as a host in a polymer matrix (i.e., the chromophore is not covalently attached to the polymer matrix). However, many guest-host composites show relatively high optical loss, which depends on both the structure of the chromophore and the polymer. Poly[bisphenol A carbonate-co-4,4′-(3,3,5-trimethylcyclohexylidene)diphenol carbonate], which is also referred to as “amorphous polycarbonate” or “APC,” has been used previously with certain chromophores to give high electro-optic activity composites with relatively low optical loss (<1.5 dB/cm). However, many chromophores do not give low optical loss composites with APC due to chromophore/polymer phase separation and resulting light scattering. Fluorinating the polymer is a method to reduce optical loss due to absorption in the polymer matrix itself, but this often leads to high optical loss in composite materials due to increased phase separation between the chromophore and the matrix. Consequently, there is still a need for a polymer matrix of an electro-optic polymer composite that is fluorinated to reduce absorptive optical loss, but does not show increased optical loss due to phase separation.

### SUMMARY OF THE INVENTION

One embodiment is an electro-optic composite comprising a polymer (i.e., matrix) having the structure

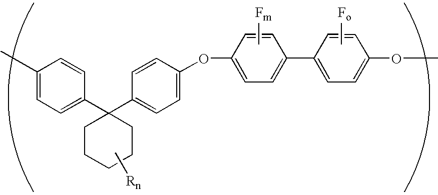

and a nonlinear optical chromophore having the structure D-π-A, wherein: R is an alkyl, aryl, heteroalkyl, or heteroaryl, group; D is a donor; π is a π bridge; A is an acceptor; n=0-4; m=1-4; and o=1-4. The electro-optic composites show a relatively low optical loss (<1.5 dB/cm) compared to composites with APC polymer matrices and similar chromophores (>2.3 dB/cm). The low optical loss is particularly surprising given that matrix is fluorinated and that the fluorinated monomer is rigid. Both fluorination and rigidity in the polymer matrix tends to increase phase separation and increase optical loss.

### BRIEF DESCRIPTION OF THE DRAWINGS

FIG. 1 illustrates donors of some embodiments of the invention.

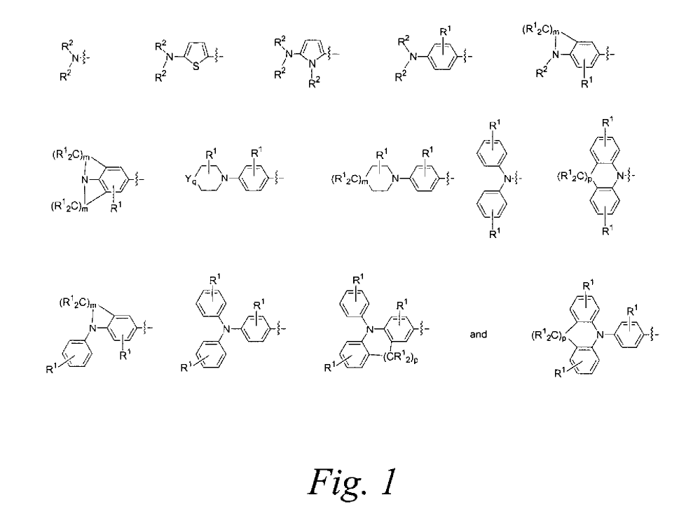

FIG. 2 illustrates acceptors of some embodiments of the invention.

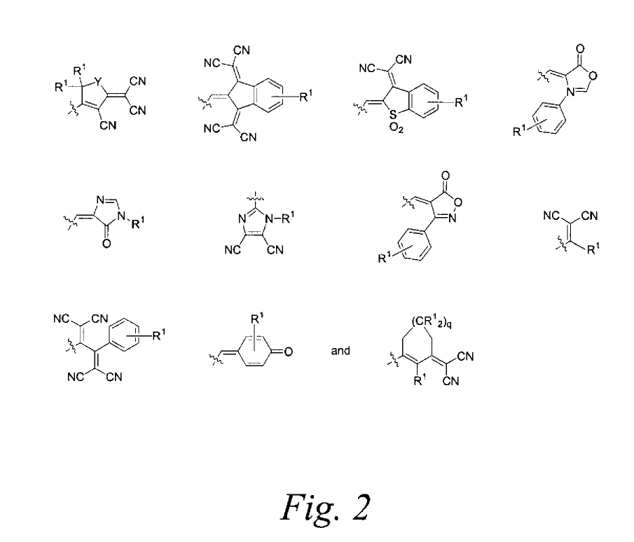

FIG. 3 illustrates the synthesis of a chromophore used in some embodiments of the invention.

FIG. 4 illustrates the synthesis of a polymer used in some embodiments of the invention.

FIG. 5 illustrates a chromophore used in some embodiments of the invention.

### DETAILED DESCRIPTION

One embodiment is an electro-optic composite comprising a polymer having the structure

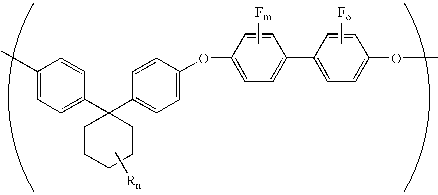

and a nonlinear optical chromophore having the structure D-π-A, wherein: R is an alkyl, aryl, heteroalkyl, or heteroaryl, group; D is a donor; π is a π bridge; A is an acceptor; n=0-4; m=1-4; and o=1-4. In some embodiments, m=4 and n=4. In some embodiments where m=4 and n=4, R=—CH₃ (i.e., a methyl group) and n=3. In other embodiments, the π bridge includes a thiophene ring having oxygen atoms bonded directly to the 3 and 4 positions of the thiophene ring. In some of those embodiments, the oxygen atoms are independently substituted with an alkyl, heteroalkyl, aryl, or heteroaryl group. Examples of chromophores where the oxygen atoms bonded directly to the 3 and 4 positions of the thiophene are independently substituted with an alkyl, heteroalkyl, aryl, or heteroaryl group comprise the structures

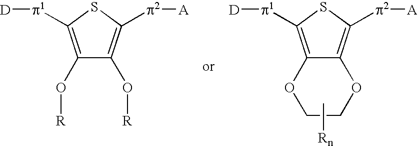

wherein: D is a donor; π¹ is a it bridge; π² is a it bridge; A is an acceptor,; and n=0-4.

In certain embodiments, the donor (D) of the chromophore is selected from the group consisting of:

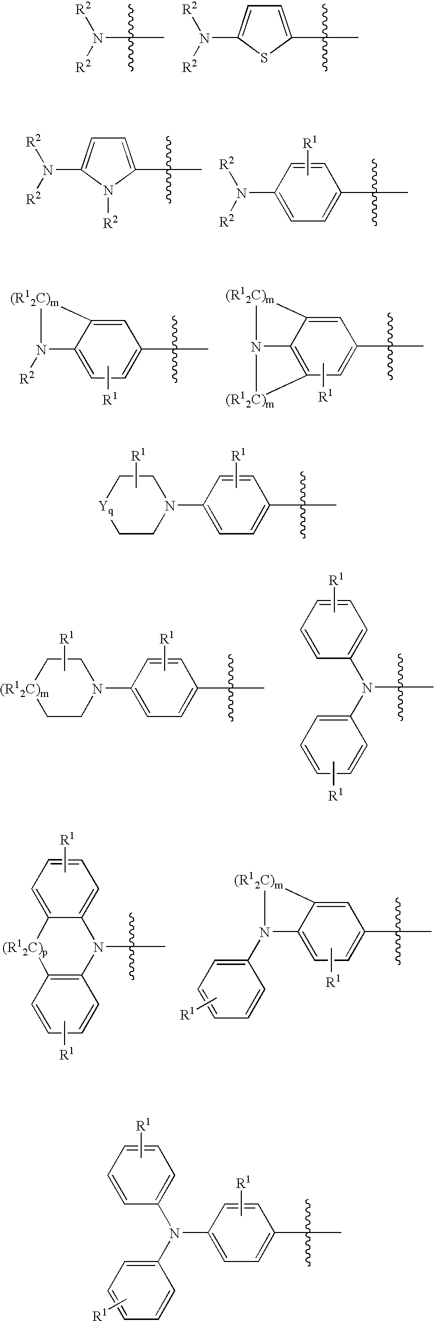

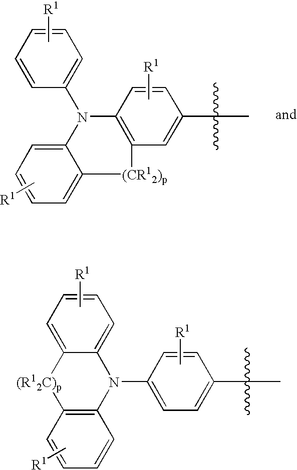

and the acceptor (A) is selected from the group consisting of

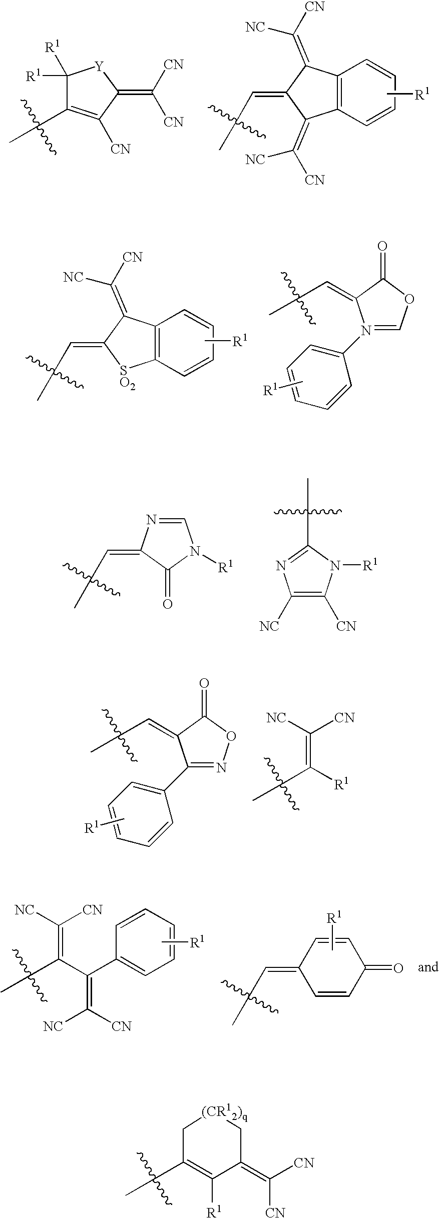

wherein independently at each occurrence: R¹ is hydrogen, a halogen, an alkyl, aryl, heteroalkyl, or heteroaryl group; R² is hydrogen, an alkyl, aryl, heteroalkyl, or heteroaryl group; Y is O, S or Se; m is 2, 3 or 4; p is 0, 1 or 2; and q is 0 or 1. In many of these embodiments, the donor is selected from the group consisting of

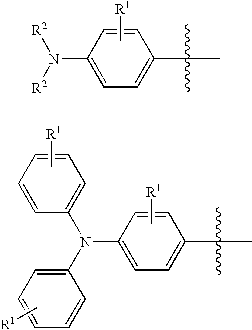

wherein, independently at each occurrence: R¹ is hydrogen, a halogen except when bonded to a carbon alpha to or directly to a nitrogen, oxygen, or sulfur atom, or an alkyl, aryl, heteroalkyl, or heteroaryl group; and R² is hydrogen or an alkyl, aryl, heteroalkyl, or heteroaryl group. In some embodiments, π¹ and π² are both

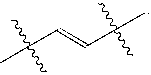

### In other embodiments, A is

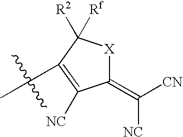

wherein R^{f} is selected from the group consisting of

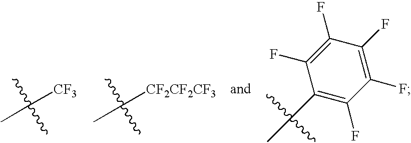

### R²is an alkyl group; and X is O or S.

A further embodiment is an electro-optic device comprising the electro-optic composite described above. The electro-optic device may comprise a Mach-Zehnder interferometer, a directional coupler, or a microring resonator.

### EXAMPLES

The following example(s) is illustrative and does not limit the Claims.

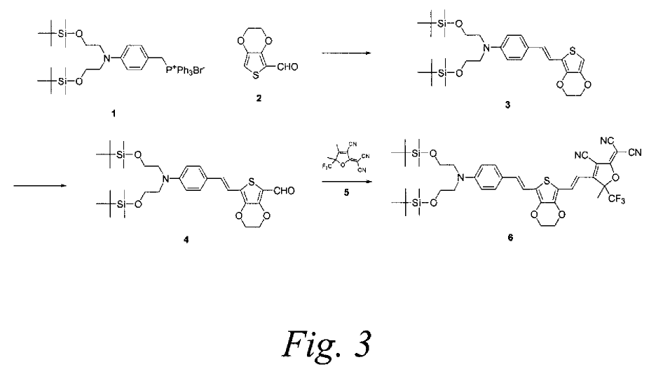

The following steps are illustrated in FIG. 3.

Compound 3: Referring to FIG. 3, compound 1 (50 g, 0.065 mol) was dissolved in 700 mL THF. At −40° C., BuLi (2.5 M, 29 mL, 0.072 mol) was added dropwise. After addition, it was warmed to rt for 30 min. Compound 2 (11.1 g, 0.065 mol) was dissolved in 300 mL THF and added to the above solution. It was stirred at rt overnight. After removing the solvent, the reaction mixture was purified by column chromatography with CH₂Cl₂. The product, 30.6 g, was obtained in 81% yield.

Compound 4: Compound 3 (30.5 g, 0.053 mol) was dissolved in 200 mL THF. At −78° C., BuLi (2.5 M, 42 mL, 0.106 mol) was added dropwise. It was warmed to −20° C. and then cooled down again. At −78° C., DMF (16.4 mL, 0.212 mol) was added. It was stirred overnight. The reaction mixture was extracted with CH₂Cl₂, washed with water, and dried over MgSO₄. After removal of the solvent, it was purified by column chromatography with CH₂Cl₂. The product, 22.93 g, was obtained in 72% yield.

Chromophore 6: Compound 4 (4.06 g, 6.7 mmol) and compound 5 (1.7 g, 6.7 mmol) were dissolved in 80 mL of EtOH. It was heated at 50° C. for 1 hour. After cooling to rt, the solid was collected by filtration, and further purified by column chromatography with CH₂Cl₂/ethyl acetate (8:0.2). The product, 3.95 g, was obtained in 70% yield.

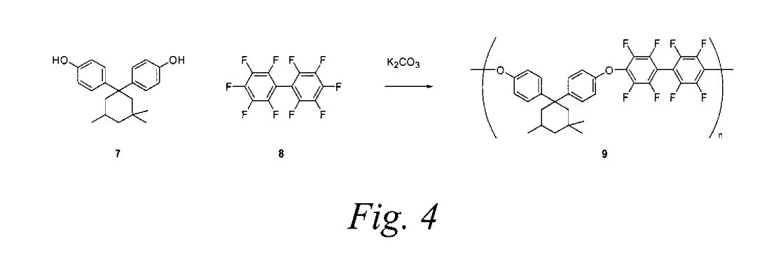

Polymer 9: Referring to FIG. 4, compound 7 (10 g, 0.0322 mol) and compound 8 (10.76 g, 0.0322 mol) were dissolved in 100 mL DMAc and K₂CO₃ (6.68 g, 0.048 mol) was then added. It was heated at 120° C. for 3 hours with Dean-Stark equipment charged with 30 mL benzene. The reaction mixture was first precipitated into MeOH/water and then further purified by dissolving in THF and precipitating with MeOH three times. The product, 17.1 g, was obtained in 88% yield.

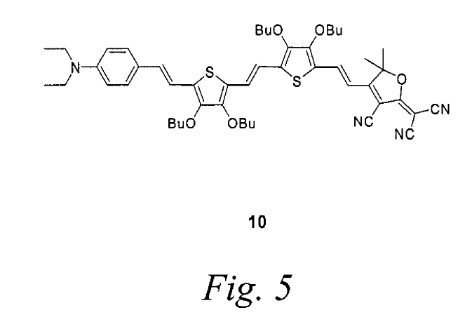

Electro-optic composites were prepared by spin coating a solution of approximately 25% by weight of chromophore 6 or chromophore 10 (FIG. 5), which is described in U.S. Pat. No. 6,750,603, in polymer 3, FIG. 26 on 2 inch indium tin oxide (ITO) coated glass wafers. The solvent for the chromophore/polymer solution was either cyclopentanone or dibromomethane. The optical loss of the composites of polymer 9 measured at 1550 nm were remarkably low (<1.5 dB/cm) compared to the same chromophores in commercial amorphous polycarbonate, “APC” (>2.3 dB/cm). The composites were electrode poled to induce electro-optic activity.

Other embodiments are within the following claims.

1. A electro-optic composite comprising a polymer having the structure 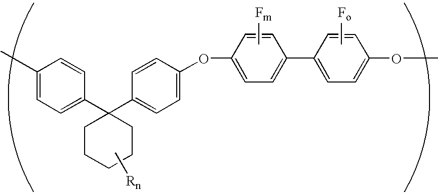
and a nonlinear optical chromophore having the structure D-π-A, wherein:
R is an alkyl, aryl, heteroalkyl, or heteroaryl, group;
D is a donor;
π is a it bridge;
A is an acceptor;
n=0-4;
m=1-4; and
o=1-4.

2. The electro-optic composite of claim 1, wherein m=4 and n=4.

3. The electro-optic composite of claim 2, wherein R=—CH₃ and n=3.

4. The electro-optic composite of claim 1, wherein the π bridge includes a thiophene ring having oxygen atoms bonded directly to the 3 and 4 positions of the thiophene ring.

5. The electro-optic composite of claim 4, wherein the oxygen atoms are independently substituted with an alkyl, heteroalkyl, aryl, or heteroaryl group.

6. The electro-optic composite of claim 5, wherein the nonlinear optical chromophore comprises 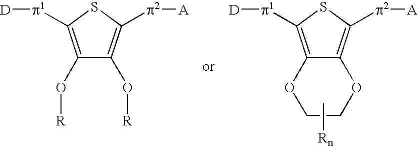
wherein: D is a donor; π¹is a n bridge; π² is a π bridge; A is an acceptor, ; and n=0-4.

7. The electro-optic composite of claim 6 wherein the donor is selected from the group consisting of. 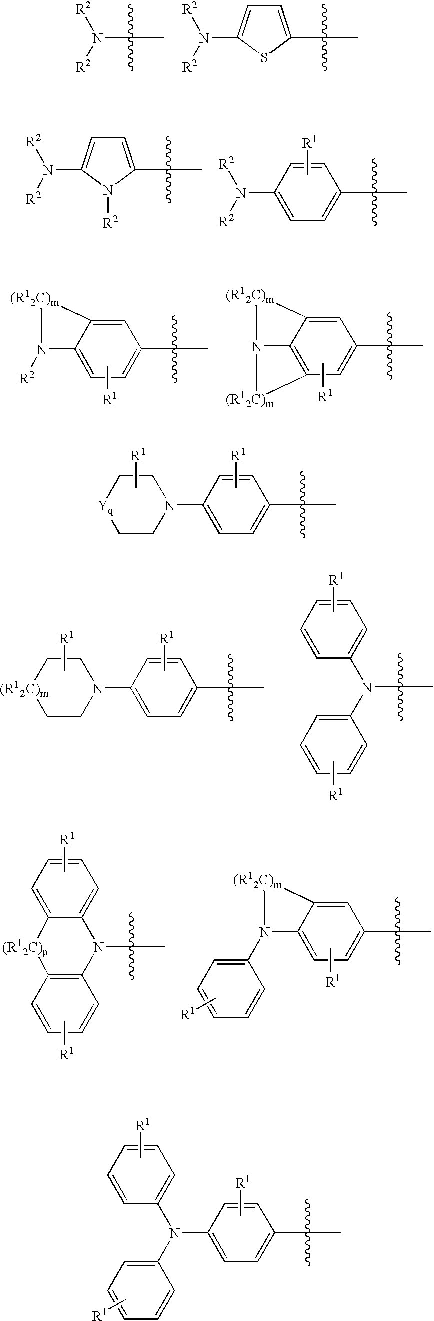 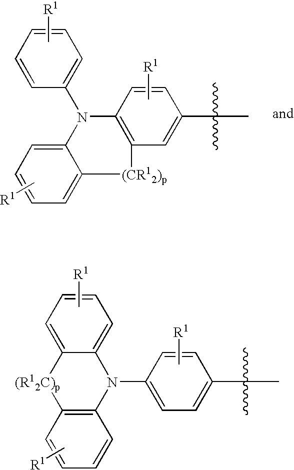
and the acceptor is selected from the group consisting of 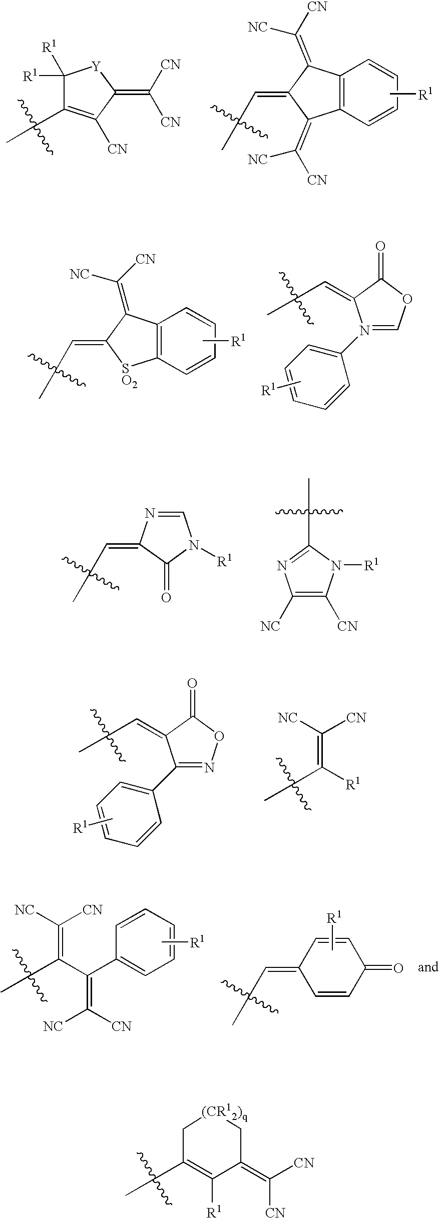
wherein independently at each occurrence: R¹ is hydrogen, a halogen, an alkyl, aryl, heteroalkyl, or heteroaryl group; R² is hydrogen, an alkyl, aryl, heteroalkyl, or heteroaryl group; Y is O, S or Se; m is 2, 3 or 4; p is 0, 1 or 2; and q is 0 or 1.

8. The electro-optic composite of claim 7, wherein the donor is selected from the group consisting of 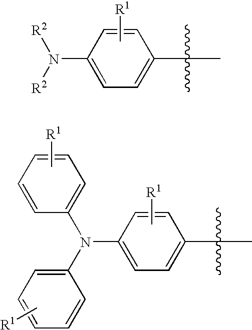
wherein, independently at each occurrence: R¹ is hydrogen, a halogen except when bonded to a carbon alpha to or directly to a nitrogen, oxygen, or sulfur atom, or an alkyl, aryl, heteroalkyl, or heteroaryl group; and R² is hydrogen or an alkyl, aryl, heteroalkyl, or heteroaryl group.

9. The electro-optic composite of claim 8, wherein π¹ and π² are both

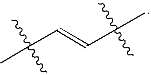

10. The electro-optic composite of claim 1, wherein A is 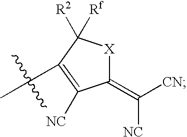
R^{f} is selected from the group consisting of 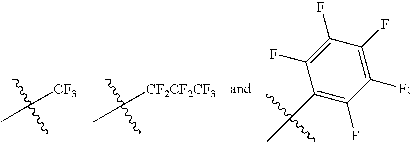
R² is an alkyl group; and X is O or S.

11. An electro-optic device comprising the electro-optic composite of claim 1.

12. The electro-optic device of claim 11, wherein the electro-optic device comprises a Mach-Zehnder interferometer, a directional coupler, or a microring resonator.
